(19) United States
(12) Patent Application Publication
(10) Pub. No.: US 2026/0106380 A1
(43) Pub. Date: Apr. 16, 2026

(54) A RADIOFREQUENCY CIRCUIT COMPONENT

(71) Applicant: QINETIQ LIMITED, Farnborough (GB)

(72) Inventor: Christopher Mark PREDDY, Farnborough (GB)

(73) Assignee: QINETIQ LIMITED, Farnborough (GB)

(21) Appl. No.: 19/117,106

(22) PCT Filed: Oct. 11, 2023
(86) PCT No.: PCT/EP2023/078145

§ 371 Date: Mar. 31, 2025

(30) Foreign Application Priority Data
Oct. 12, 2022 (GB) 2215014.8

(51) Int. Cl. H01Q 13/10; H01P 3/12; H01P 5/12; H01P 11/00

(52) U.S. Cl. CPC H01Q 13/10; H01P 3/121; H01P 3/122; H01P 5/12; H01P 11/003

(57) ABSTRACT

An RF circuit component for incorporation into a composite article. The component includes a dielectric substrate and a composite fibre veil which is treated with a conductive material. The composite fibre veil encloses a part of the dielectric substrate so as to delimit a wave propagation region in said part of the dielectric substrate.

### Field

This specification concerns Radiofrequency (RF) circuit components, such as substrate integrated waveguides, which are suitable for being incorporated into composite component articles.

### BACKGROUND

RF circuit components have many communication and sensing applications. One example of an RF circuit component is an electromagnetic (EM) waveguide, which is used as a transmission line that confines and conducts EM energy from one point to another. Conventional EM waveguides have the form of a hollow rectangular metal pipe, which offers immunity against radiation losses and presents low insertion losses.

With an increasing need for the miniaturization of RF circuit components, a specific type of EM waveguide was developed, a so-called substrate integrated waveguide (SIW). An SIW is a type of waveguide transmission line suitable for transmission of RF power and information. An SIW comprises a dielectric substrate covered on two faces by rigid and planar metallic layers. Embedded within the substrate are two parallel rows of metallic via-holes. The planar metallic layers and the rows of via-holes delimit a wave propagation area. SIWs can be as thin as a sheet of paper and can be integrated into small spaces such as printed circuit boards (PCBs).

It is envisaged that RF circuit components including SIWs will be increasingly applied to fibre-reinforced composite articles, such as fibre-reinforced-plastic (FRP), to add multi-functionality to those articles. An FRP comprises a polymer matrix (such as a resin) reinforced with fibre (e.g. carbon fibres, glass fibres etc.). FRP materials such as carbon fibre reinforced plastic (CFRP) generally exhibit high temperature resistance, abrasion resistance, corrosion resistance and thermal conductivity, and a high specific strength. They have utility across many industries, and can be used as structural materials, e.g. for aircraft, electromagnetic shielding materials etc. However, a known problem is that it is often difficult to incorporate RF circuit components with composite articles. For example, composite articles often have complex shapes and conventional RF circuit components are not able to be easily attached to those structures, or integrated into the structures without compromising the structural integrity of the material. Consequently, RF circuit components are typically applied onto the exterior of existing composite articles using crude attachment means, resulting in increased weight, size and potentially reduced aerodynamic performance.

Aspects of the present invention seek to provide an RF circuit component that addresses the foregoing.

### SUMMARY OF INVENTION

According to an aspect of the present invention, there is provided an RF circuit component suitable for being incorporated into a (e.g. fibre-reinforced) composite article, the RF circuit component comprising:
a dielectric substrate; and
a composite fibre veil which has been treated with an electrically conductive material so as to impart an electrically conductive property to the composite fibre veil;
wherein the composite fibre veil encloses a part of the dielectric substrate so as to delimit a wave propagation region in said part of the dielectric substrate.

The RF circuit component may extend in a longitudinal direction between a first end and a second end and the (treated) composite fibre veil may enclose a longitudinal extent of the RF circuit component. The longitudinal extent may be the entire length of the dielectric substrate, or only a part thereof.

To improve transmission efficiency, the (treated) composite fibre veil may entirely wrap around the dielectric substrate along the longitudinal extent, to ensure that EM waves are substantially entirely confined along the longitudinal extent. That is, the dielectric substrate may be enclosed by the (treated) composite fibre veil along all of its lateral surfaces (i.e. those that extend longitudinally). The dielectric substrate may be entirely enclosed by the (treated) composite fibre veil when viewed in longitudinal cross section. The dielectric substrate may be exposed at one or both of the first and second ends of the RF circuit component, e.g. to connect to one or more electrical connectors. Alternatively, the dielectric substrate may be enclosed and covered by the composite fibre veil at one or both of the first and second ends, depending on the application.

The RF circuit component may be an electromagnetic waveguide.

The electromagnetic waveguide may be a slotted waveguide antenna in that the composite fibre veil comprises one or more slots to expose the dielectric substrate through the one or more slots.

The RF circuit component may be a power splitter. This may be achieved by virtue of the circuit component having, in embodiment, three or more arms, each of which comprises a dielectric substrate enclosed by the electrically treated composite fibre veil.

The dielectric substrate may be any material which is an electrical insulator that can be polarised by an applied electric field. A dielectric material may have comparatively higher energy storing capacity (by means of the polarisation) than other types of material.

The dielectric substrate may have greater or improved dielectric properties than that of the composite fibre veil and the electrically conductive material which form part of the RF circuit component. Where the RF circuit component is to be integrated or embedded in a (e.g. fibre-reinforced) composite article, the dielectric substrate may have greater or improved dielectric properties than components of the composite article, such as composite (e.g. fibrous) materials with which the RF circuit component is (e.g. directly) integrated or bonded to form the article.

In embodiments, the dielectric substrate is a different material to the treated composite fibre veil or other composite materials which form part of the RF circuit component or composite article.

The dielectric substrate may be a glass-fibre-reinforced-polymer. The dielectric substrate may be a foam dielectric substrate, e.g. a polymethacrylimide (PMI) foam.

The composite fibre veil may be in its raw form. That is, the composite fibres are not infused or pre-impregnated with (or otherwise have applied thereto) a resin material, in some embodiments.

The composite fibre veil may be a non-woven composite (e.g. carbon) fibre veil.

The conductive material may be copper.

In some embodiments, the composite fibre veil has been treated in that a surface of the composite fibre veil (e.g. in its raw form) has a layer of conductive material deposited thereon.

The layer of conductive material may be proximate the dielectric substrate. The layer of conductive material may be in direct contact with the dielectric substrate. The layer of conductive material may have a first thickness in a first region and a second, different thickness in a second region. It will be appreciated that the veil may have some regions where the conductive material has some surface level thickness variations as a result of manufacturing intolerances or other errors. However, in this embodiment the first thickness and the second thickness are thickness variations which are deliberately applied during manufacture, and so are in addition to any manufacturing errors. The composite fibre veil may be deliberately made to have regions where the conductive material has different thicknesses to materially change the electrical conductivity of said regions. For example, electrical connectors may be formed by thicker regions of the layer of conductive material. This may obviate the need for using separate metal connectors which will need to be attached to the composite materials using conventional means, e.g. bolts or adhesive.

According to another aspect of the present invention, there is provided a (e.g. fibre-reinforced) composite article comprising an RF circuit component, wherein the RF circuit component is formed as an integral part of the composite article. The composite article may comprise one or more composite (e.g. fibre) materials that form part of a body of the article, with which the RF circuit component is to be integrated. The RF circuit component may be the same RF circuit component as that described above, i.e. it may have the features of any one or more of the preceding statements or embodiments described herein. Accordingly, the composite article may comprise the treated composite fibre material veil and a dielectric substrate enclosed by the treated composite fibre material veil. The dielectric substrate may be a different material to the one or more composite (e.g. fibre) materials that form part of a body of the article.

According to another aspect of the present invention, there is provided a method of manufacturing a (e.g. fibre-reinforced) composite article, comprising:
providing an RF circuit component; and
integrating, e.g. bonding, the composite fibre veil of the RF circuit component with composite (e.g. fibrous) materials to form the article.

The RF circuit component in accordance with this aspect may be the same RF circuit component as that described above, i.e. it may have the features of any one or more of the preceding statements or embodiments described herein. Further, the step of providing an RF circuit component may comprise any method of manufacturing the RF circuit component described herein.

The step of integrating the RF circuit component with composite materials to form the article may comprise: applying a resin to an assembly of the RF circuit component and composite materials and curing the resin-applied assembly.

According to another aspect of the present invention, there is provided a method of manufacturing an RF circuit component, the method comprising:
providing a composite fibre veil and a dielectric substrate;
treating the composite fibre veil with electrically conductive material to impart an electrically conductive property to the composite fibre veil; and
enclosing a part of the dielectric substrate with the treated composite fibre veil so as to delimit a wave propagation region in said part of the dielectric substrate.

Treating the composite fibre veil with electrically conductive material may comprise coating the composite fibre veil with a layer of the conductive material, where the layer has a first thickness, e.g. at or above about 400 nm, corresponding to a predetermined conductivity level for the RF circuit component.

The step of coating the composite fibre veil with a layer of conductive material may comprise: applying (e.g. depositing or sputtering) the conductive material by thin film deposition for a predetermined time period which corresponds to the first thickness.

The step of coating the composite fibre veil with a layer of conductive material may comprise:
applying (e.g. depositing or sputtering) the conductive material by thin film deposition for a first predetermined time period in a first surface region of the composite fibre veil to deposit a layer of conductive material having a first thickness in the first surface region; and
applying (e.g. depositing or sputtering) the conductive material by thin film deposition for a second predetermined time period in a second surface region of the composite fibre veil to deposit a layer of conductive material having a second thickness in the second surface region;
wherein the first time period is different to the second time period and the first thickness is different to the second thickness.

The skilled person will appreciate that except where mutually exclusive, a feature described in relation to any one of the above aspects may be applied to any other aspect. Furthermore, except where mutually exclusive, any feature described herein may be applied to any aspect and/or combined with any other feature described herein.

### BRIEF DESCRIPTION OF DRAWINGS

Embodiments of the invention will now be described by way of non-limiting example with reference to the drawings, in which:

FIG. 1 is a schematic diagram illustrating a top view and a longitudinal cross-sectional view (taken along a line A-A) of an RF circuit component in accordance with an embodiment of the present invention;

FIG. 2 is a schematic diagram illustrating a top view of the RF circuit component of FIG. 1 without a composite fibre veil;

FIG. 3 is a schematic diagram illustrating a top view of the RF circuit component of FIG. 1 in a partially wrapped state;

FIG. 4 is a flow chart illustrating a method of manufacturing a composite component article having integrated RF functionality;

FIG. 5 is a schematic diagram illustrating a top view and a longitudinal cross-sectional view (taken along a line B-B) of an embodiment in which the RF circuit component is a power splitter; and

FIG. 6 is a schematic diagram illustrating a top view and a longitudinal cross-sectional view (taken along a line C-C) of an embodiment in which the RF circuit component is a slotted waveguide antenna.

Like reference numerals will be used throughout the detailed description to denote like features of the invention.

### DETAILED DESCRIPTION

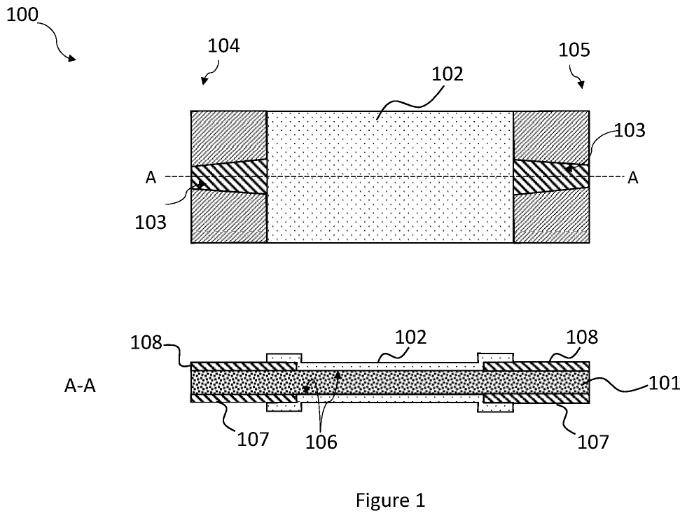

With reference to FIGS. 1 to 3, there is generally shown an RF circuit component 100 in accordance with an embodiment of the present invention. In the illustrated example, the RF circuit component 100 includes a SIW which is to be integrated with a composite article, such as an aircraft wing.

The RF circuit component 100 comprises a dielectric substrate 101, a composite fibre veil 102 which has been treated with an electrically conductive material and two electrical connectors 103. The SIW is formed by wrapping the composite fibre veil 102 entirely around a longitudinal extent of the dielectric substrate 101 between the two electrical connectors 103. In that way, the composite fibre veil 102 can be said to enclose the entire circumference or lateral perimeter of the dielectric substrate 101 along a longitudinal extent thereof.

The dielectric substrate 101 has a substantially planar profile and extends substantially the entire length of the RF circuit component 100 between a first longitudinal end 104 and a second longitudinal end 105 thereof. The dielectric substrate 101 may be a glass fibre based substrate, for example a glass-fibre-reinforced-polymer. However, in preferred embodiments the dielectric substrate 101 is a dielectric foam, e.g. a polymethacrylimide (PMI) foam. A suitable commercial-off-the-shelf (COTS) PMI foam is the ROHACELL® 31 IG-F PMI foam (68 r=1.05, tanδ=0.0019).

The Applicant has found that, by using a dielectric foam instead of other dielectric substrates, the transmission efficiency of the SIW can be increased. This is because foam is a low loss substrate and can therefore be used to reduce signal attenuation throughout the SIW. This is especially the case in comparison to hypothetical arrangements in which the dielectric substrate is a glass substrate. For example, losses may be reduced from 5 Nepers/m (as is the case for glass substrates) to 1 Nepers/m for the PMI foam substrate.

The composite fibre veil 102 is a non-woven fabric, sheet or web structure which has been formed by bonding discontinuous composite fibres together, e.g. using mechanical, thermal or chemical means. While the veil may contain a binder to aid the bonding of the fibres, the composite fibre veil 102 may be regarded as being in its “raw form” in that the composite fibres are not infused or pre-impregnated with a resin material. Such veils are flexible, porous and have good formability.

Any type of composite fibres may be used for the veil, and the specific fibre material may be selected based on a number of factors including the type of composite fibres that are to be used in the final composite article. In the present embodiment, the composite fibre veil 102 is made of carbon fibres, specifically it is a COTS non-woven carbon-fibre veil. Carbon fibres are composite fibres typically about 5 to 10 micrometres in diameter and are composed of carbon atoms bonded into a chain. Carbon fibres are lightweight and the carbon fibre veil 102 has an area weight of 20 grams-per-square-meter (gsm), although in other embodiments the veil may have an area weight as low as 4 gsm.

The composite fibre veil 102 has been treated with Copper so as to impart an electrically conductive property thereto. Specifically, the composite fibre veil 102 is coated with a layer of Copper that forms a first surface 106 of the veil 102. The Copper layer may be applied directly to the composite fibre veil 102 in its raw form. However, in this embodiment, an intermediate layer of Nickel is applied directly to the raw composite fibre veil 102 before the layer of Copper is then applied on top of the Nickel layer on the veil 102 exterior. The layer of Nickel may increase adhesion of the Copper to the veil. Materials other than Nickel may also be suitable for this purpose, and may therefore be used instead of Nickel in some embodiments.

In the present embodiment, the Copper layer has a thickness of approximately 450 nanometres (nm). The Applicant has found that this thickness of Copper imparts sufficient electrical conductivity to the carbon fibre veil 102 for confining EM waves, while retaining veil flexibility. However, in other embodiments, it may be appropriate to deposit the conductive material in different quantities (thicknesses) to impart sufficient electrically conductivity to the carbon fibre veil 102. The appropriate thickness to use may depend on the specific type of conductive material being used to form the conductive layer.

Regardless of the specific conductive material, the thickness of the conductive layer may be selected or set depending on the frequency of the alternating current (AC) applied to the RF circuit component. A thicker layer may be used for applications where a lower AC frequency is to be applied to the RF circuit component, to reduce attenuation losses through the conductor. In that regard, at lower AC frequencies, the skin depth of the conductor will be larger such that a thicker layer of conductive material will effectively contain more of the current flow through the conductor, thereby reducing attenuation losses at those lower frequencies. For higher AC frequencies, the current flow (current density) through the conductor moves towards the surface of the conductor by virtue of the skin effect, resulting in a smaller skin depth that can be effectively contained (i.e. with low attenuation losses) with a thinner layer of conductive material. The thickness of the conductive layer may be set based on the skin depth of the conductive material, e.g. to provide a conductive layer having a predictable and acceptable level of attenuation losses. The thickness of the conductive layer may be set to a value that is a predetermined fractional percentage of the skin depth, which corresponds to an acceptable attenuation loss.

As mentioned above, the SIW of the present embodiment is created by wrapping the treated composite fibre veil 102 around a part of the dielectric substrate 101. The layer of electrically conductive material of the veil 102 in effect forms a conducting wall that confines EM waves and delimits a wave propagation region in the enclosed/wrapped part of the dielectric substrate 101. The use of a veil coated with an electrically conductive material may reduce the attenuation normally experienced with carbon-based microwave circuit components.

The veil 102 is wrapped around the dielectric substrate 101 such that the layer of conductive material on the first surface 106 of the veil 102 is on an interior surface of the RF circuit component 100 and is proximate (e.g. in direct contact with) the dielectric substrate 101. In this way, the efficiency of the RF circuit component 100 may be increased because the current density in the composite fibre veil 102 will be highest in a region closest to the dielectric substrate 101. It also exposes the carbon fibres in the veil 102 to the exterior of the RF circuit component 100, thereby allowing a resin to more easily impregnate the carbon fibre veil 102 during the article manufacturing process.

Although not shown, one or more additional layers of carbon fibre material may be provided in regions of the RF circuit component 100, as may be desired to increase the structural strength and stability of the overall circuit component 100. Further, a resin film may be inserted between the carbon fibre veil 102 and the substrate 101 for improved adhesion of the carbon fibre veil 102 to the dielectric substrate 101.

The SIW directs EM energy along the wave propagation region in a longitudinal direction between the two electrical connectors 103 at opposite ends 104, 105 of the RF circuit component 100. A respective one of the electrical connectors 103 acts as a power input port, while the other one acts as a power output port. The connectors 103 can be of any type known in the art, and may vary depending on the desired application. In the present embodiment, each connector 103 is a microstrip-SIW transition line for carrying EM, e.g. microwave-frequency, signals to and from the SIW. The microstrip connector 103 comprises ground 107 and trace 108 conductors that are parallel and spaced apart on opposite sides of the dielectric substrate 101. The ground 107 and trace 108 are fabricated using two separate 0.2 mm-thick FR-4 substrates, located above and below the dielectric substrate 101.

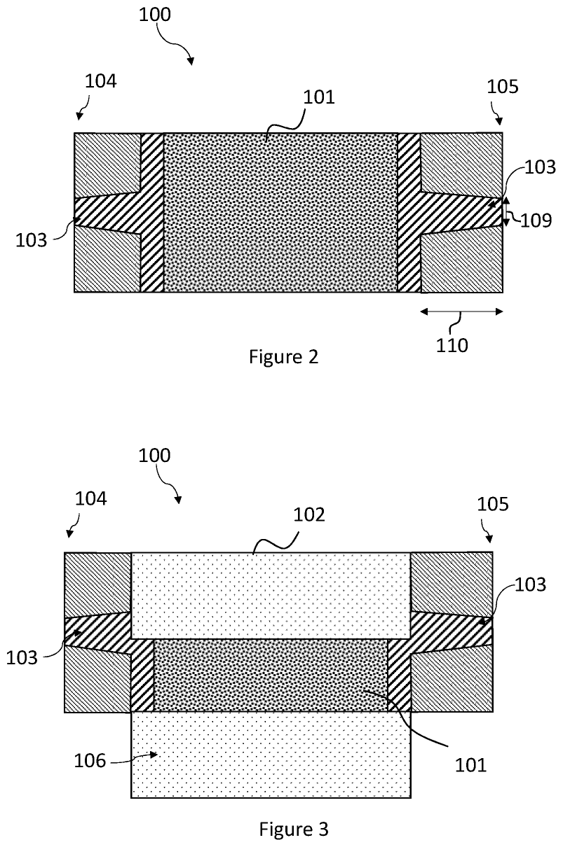

The shape and material properties of the ground 107 and trace conductors 108 are tailored to ensure desired electrical properties that enable optimum transition of EM signals from the microstrip to the SIW. In the present embodiment, and as best shown in FIG. 2, the microstrip connector 103 has a tapered profile in that it has a transverse width 109 that is reduced with increased distance 110 from the corresponding (e.g. adjacent) end 104, 105 of the RF circuit component 100. The connector 103 covers the entire transverse breadth of the RF circuit component 100 at a longitudinal position adjacent the SIW. This specific shape may be advantageous to match the impedance of the microstrip-SIW transition line to the impedance of the SIW. In this example embodiment, the trace conductor 108 has an impedance of around 50 ohms.

In the present embodiment, and as best shown in the cross-sectional view in FIG. 1, the carbon fibre veil 102 overlaps a longitudinal extent of the electrical connectors 103 which are opposite the longitudinal ends 104, 105 of the RF circuit component 100. This forms an electrical connection between the connectors 103 and the composite fibre veil 102, thereby ensuring efficient operation of the RF circuit component.

In the manner described above, the present invention provides an RF circuit component which is formed using a composite fibre material, e.g. carbon fibre, which is typically used as a building block for composite articles, e.g. fibre-reinforced composite articles. Accordingly, the RF circuit component can be more easily integrated in composite articles, including those with complex shapes. For example, a composite article such as a composite aircraft wing can be manufactured to have an RF circuit component as an integral part thereof. This has many advantages for providing composite articles with RF functionality but without compromising the structural integrity of the articles or substantially increasing the size, weight and potentially aerodynamic profile of the articles. For example, thin and lightweight RF circuit components may be fabricated such that they are able to be embedded within the body of a composite article, or to be conformal to the shape of a surface of the composite article, but without compromising the structural integrity of the article.

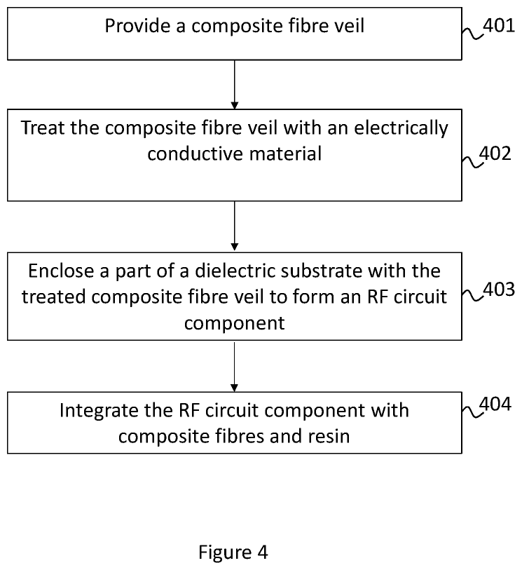

A method of manufacturing a fibre-reinforced composite article having an RF circuit component for increased RF capabilities will now be described with respect to FIG. 4.

The method begins, at block 401, wherein a composite fibre veil is provided. The composite fibre veil is, in embodiments, a flexible non-woven carbon veil such as that described above with respect to FIGS. 1-3. The composite fibre veil 102 is porous and in its raw form (without any resin) at this stage.

At block 402, the raw composite fibre veil is treated with an electrically conductive material, such as Copper, to impart an electrically conductive property to the composite fibre veil.

This may comprise applying a layer of Nickel and a layer of electrically conductive material to the raw composite fibre veil 102 by physical vapour deposition (PVD) methods known in the art, such as a thin film sputter deposition technique. By treating the composite fibre veil while in its raw form, the layer of conductive material may be applied more uniformly in the region being treated, providing more predictable and accurate electrical characteristics across the region.

The conductive material is applied to the surface of the veil 102 for a predetermined time period which allows a layer having a corresponding thickness of conductive material to form. Where the conductive material is Copper, the layer of Copper may be deposited for a time period such that it has a final thickness of at least about 400 nm, e.g. 450 nm, corresponding to a predetermined minimum conductivity level for the RF circuit component.

At block 403, a part of a dielectric substrate is enclosed with the treated composite fibre veil so as to delimit a wave propagation region in the enclosed part of the dielectric substrate to form an RF circuit component. The composite fibre veil may also enclose parts of one or more or all electrical conductors that form the RF circuit component. In that regard, it will be appreciated that the number and type of electrical conductors may vary from one RF circuit component to another, depending on the type of RF circuit component in question.

At block 404, the RF circuit component 100 is integrated with other (raw) composite fibrous materials which may or may not be of the same type (e.g. carbon fibres) as that of the composite fibre veil 102 of the RF circuit component, to form a fibre-reinforced composite article. The composite article may be part of an aircraft wing, for example.

Block 404 of the method may comprise assembling the RF circuit component 100 and one or more other composite fibrous materials, such as fabrics or other composite fibre veils. The composite fibre veil 102 of the RF circuit component 100 may overlap or be covered with the one or more separate composite fibrous materials (or parts thereof), as may be desired to create the final article. The RF circuit component 100 and other composite materials 501 may be assembled in the cavity of a mould tool or on a plate of a vacuum cavity etc., to form the shape of the final composite article 500. The RF circuit component may be conformable to form the shape of the final composite article 500.

A resin, such as epoxy, is then applied to the assembled RF circuit component and fibrous materials. This resin can be provided using a method such as resin infusion, through the use of a resin film, or by using a pre-impregnated fabric material to transfer resin to the veil. The resin-applied assembly is then cured and optionally pressurised to bind the composite fibre veil and other fibrous materials together to form the final fibre-reinforced composite article.

It will be appreciated, however, that the RF circuit component may be formed into a final fibre-reinforced composite article using any suitable fabrication routine known in the art. In the manner described above, a composite article is formed such that the body of the article comprises the RF circuit component 100 as an integral part thereof. The RF circuit component 100 may be an integral part of the composite article in that it is intrinsically fused or bonded with the other fibrous materials in the article by the cured resin. This may ensure the structural integrity of the article. This is in contrast to hypothetical arrangements where an RF circuit component is separately attached to a composite article using conventional attachment means, such as bolts, adhesives etc.

The invention has been described above with respect to treating the composite fibre veil by depositing a layer of electrically conductive material (e.g. Copper) to the surface thereof. However, the thickness of the layer of conductive material need not be uniform across the surface area of the composite fibre veil. Instead, in all of the embodiments of the invention the composite fibre veil may have surface regions in which the layer of conductive material is thicker (or thinner) than that of the conductive material in other surface regions. The thickness of the conductive layer may be tailored by controlling the period of time for which the conductive material is applied to the composite fibre veil, e.g. in a vapour deposition method. In this way, it is possible to form regions with different electrical properties. It may, for example, be possible to form the electrical connectors 103 as a part of the composite fibre veil itself, by depositing additional (thicker) conductive material in regions of the composite fibre veil that are to form the connectors. For example, the thicker regions of the conductive material may be tailored such that they form microstrip transitions such as those described above with respect to FIGS. 1-3. This may obviate the need for separate electrical conductors to be fitted to the SIW.

While the invention has been described above with respect to embodiments in which the raw form of the composite fibre veil is treated with an electrically conductive material, the carbon fibre veil need not be in its raw form for that process. In all embodiments of the invention, the composite fibre veil to be treated with an electrically conductive material may itself be a “pre-preg” composite fibre veil, i.e. a veil comprising composite fibres that have been pre-impregnated (and partially cured) with a resin. One example of such a pre-preg material is carbon-fibre-reinforced-polymer. In such cases, the treated pre-preg will be ready to be cured without the addition of any more resin, such that the method described above with respect to FIG. 4 can omit the step of applying (e.g. impregnating) the composite fibre veil with a resin before curing. Instead, block 404 of the method may comprise assembling the RF circuit component with other pre-preg materials before curing the assembly to form the final composite article.

Further, while the invention has been described above with respect to embodiments in which the composite fibre veil is coated with a layer of conductive material (e.g. and optionally a Nickel layer), this is not required. In any or all embodiments of the invention, the carbon fibre veil may be treated by coating individual fibres of the raw composite fibre veil with the electrically conductive material (and in some cases Nickel). This may be achieved, for example, using electro-coating techniques known in the art.

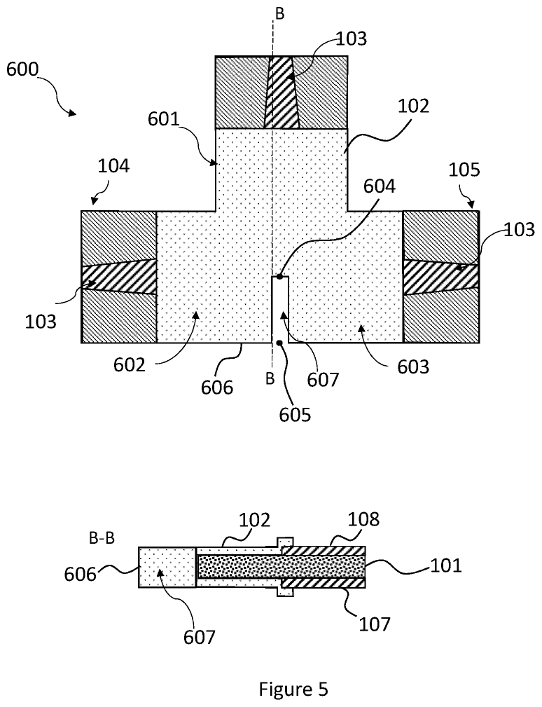

The SIW has been described above as being suitable for directing EM energy between connectors 103 at two longitudinal ends 104, 105 of the RF circuit component 100. However, the invention is not limited to that specific configuration or application. In some embodiments, the RF circuit component may be configured as a power splitter, as will now be described with respect to FIG. 5.

FIG. 5 is a schematic diagram illustrating a top view and a longitudinal cross-sectional view (taken along a line B-B) of an RF circuit component 600 in the form of a power splitter.

The structure of the RF circuit component 600 is substantially the same as that described above with respect to the RF circuit component 100 of FIGS. 1-3 except that, in this embodiment, the RF circuit component 600 comprises an additional arm 601 which extends perpendicularly to the longitudinal direction defined between the first longitudinal end 104 and the second longitudinal end 105. The arm 601 extends from a substantially central region of the RF circuit component 600 between the first longitudinal end 104 and the second longitudinal end 105.

The planar dielectric substrate 101 is shaped to define a power splitter in that it has a T-shaped profile, having three arms 601, 602, 603, extending from a common point 604 of the RF circuit component 600. For each arm, there is provided an electrical connector 103 at the distal end opposite the common point 604. Each connector 103 may be substantially the same as those described above with respect to FIGS. 1-3, i.e. comprising a microstrip with trace 108 and ground 107 conductors on opposite broad surfaces of the dielectric substrate 101.

A composite fibre veil 102 which has been treated with an electrically conductive material in the manner described above with respect to FIGS. 1-4 is wrapped around the dielectric substrate 101 so as to entirely enclose the dielectric substrate 101 in the parts (e.g. arms 601, 602, 603) that need to confine and direct EM energy between the connectors 103. Accordingly, the veil 102 entirely wraps around the substrate 101 to define a SIW having a wave propagation region between the connectors 103.

The RF circuit component 600 may be suitable for use as a power splitter, wherein one of the connectors 103 act as a power input port, while the other two connectors 103 act as power output ports. The SIW may couple a defined amount of EM power from the input port to the output ports.

The shape, size and number of arms/ports may be tailored as desired to achieve a given power split between the output ports. In the embodiment of FIG. 5, the RF circuit component 600 is configured with centred and mutually shaped and sized arms, such that EM power entering the SIW via the input port is split equally between the two output ports. Further, in the present embodiment, the dielectric substrate 101 comprises a cut out section 607 where the surfaces of the dielectric substrate 101 in the cut-out section 607 are also entirely wrapped by the composite fibre veil 102. The cut-out section 607 is a rectangular slot extending from a longitudinal midpoint 605 on a transverse side 606 of the power splitter 600 between the first and second longitudinal ends 104, 105 to the common point 604. Such cut-out sections 607 of the dielectric substrate 101, when wrapped by the composite fibre veil 102, may in effect create structures (walls or boundaries) within the wave propagation region that help to guide propagation within the SIW for efficient power splitting.

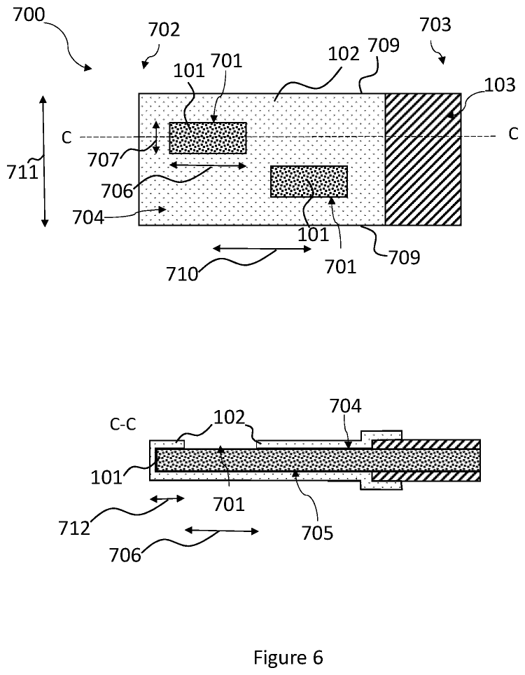

Another application of the RF circuit component of the present invention is in the field of antenna design. For example, the RF circuit component may be configured as a SIW antenna, as will now be described with respect to FIG. 6.

FIG. 6 is a schematic diagram illustrating a top view and a longitudinal cross-sectional view (taken along a line C-C) of an embodiment in which the RF circuit component is a slotted SIW antenna 700.

There is generally shown a slotted SIW antenna 700 which comprises a planar dielectric substrate 101 wrapped by a treated composite fibre veil 102 which has two holes or slots 701 cut out of it to expose the dielectric substrate 101.

The dielectric substrate 101 extends longitudinally between a first longitudinal end 702 and a second longitudinal end 703 of the antenna 700. At the second longitudinal end 703, there is an electrical connector 103 (e.g. a microstrip) which may be connected to an EM power source (not shown) for radiation by the antenna 700.

The composite fibre veil 102, which has been treated with an electrically conductive material in a manner as described above with respect to FIGS. 1-4, is wrapped around the dielectric substrate 101 to cover the broad planar surfaces 702, transverse edges 709 and the first longitudinal end 702 of the dielectric substrate 101, to form the SIW. However, the slots 701 are cut out of the veil 102 to expose surface regions on one broad planar surface 704 of the dielectric substrate 101, but not the other 705.

The slots 701 are provided to induce radiation from the substrate 101 through the slots 701. The longitudinal extent 706 of each slot 701 is selected based on the operating frequency of the antenna 700. The transverse extent (width) 707 of each slot 701 determines the bandwidth of the antenna 700.

The longitudinal centrepoints of the two slots 701 are separated by a distance 710 of λ_{g}/2 to ensure they radiate in phase, where λ_{g} is the guided wavelength within an SIW of width 711 at the antenna centre frequency. The first slot is a distance 712 of λ_{g}/4 from the first longitudinal end 702 of the antenna 700, so that the slots 701 are positioned at the points of peak amplitude for the E-field standing wave.

When the antenna 700 is driven by an applied RF current, a standing wave is maintained within the SIW and the slots 701 radiate an EM field. The shape and size of the slots 701, as well as the driving frequency, determine the radiation pattern. It has been found that the antenna 701 can produce a radiation pattern consistent with that expected from a conventional slotted waveguide antenna.

Although the antenna of FIG. 6 has been described as having two slots 701, it will be appreciated that this is only one of many different possible embodiments. The antenna may be constructed with only one slot, or more than two slots, as may be desired. Further, the slots 701 may have different orientations and positions on the broad planar surface 704 of the dielectric substrate 101 to that shown in the specific example embodiment of FIG. 6. In that regard, it will be appreciated that the position, shape and orientation of the slots 701 will determine how they radiate, and can be tailored accordingly.

While the invention has been described above with respect to enclosing the dielectric substrate with a single treated composite fibre veil, it will be appreciated that the dielectric substrate may instead be enclosed by a plurality of (electrically treated) composite fibre veils. This may be desirable for wrapping dielectric substrates having complex shapes that are not readily suitable for being wrapped by a single continuous veil. In such cases, separate (treated) composite fibre veils may be overlapped at connection points to ensure that the dielectric substrate is fully enclosed at those points.

In view of all of the above, it can be seen that the present invention provides lightweight and mechanically robust RF circuit components made using composite materials, and therefore facilitates the integration of many different RF circuit components with composite articles. That is, the treatment of an electrically conductive material to a composite fibre veil helps to increase the efficiency of the SIW, and the application of this to the veil has benefits for the integration of RF, e.g. microwave, circuits into composite articles.

It will be appreciated that whilst various aspects and embodiments of the present invention have heretofore been described, the scope of the present invention is not limited to the embodiments set out herein and instead extends to encompass all methods and arrangements, and modifications and alterations thereto, which fall within the scope of the appended claims.

1. An RF circuit component suitable for being incorporated into a composite article, the RF circuit component comprising:
a dielectric substrate; and
a composite fibre veil which has been treated with an electrically conductive material so as to impart an electrically conductive property to the composite fibre veil;
wherein the composite fibre veil encloses a part of the dielectric substrate so as to delimit a wave propagation region in said part of the dielectric substrate.

2. An RF circuit component as claimed in claim 1, wherein the RF circuit component is an electromagnetic waveguide.

3. An RF circuit component as claimed in claim 2, wherein the electromagnetic waveguide is a slotted waveguide antenna in that the composite fibre veil comprises one or more slots to expose the dielectric substrate through the one or more slots.

4. An RF circuit component as claimed in claim 1, wherein the RF circuit component is a power splitter.

5. An RF circuit component as claimed in claim 1, wherein the dielectric substrate is a glass-fibre-reinforced-polymer.

6. An RF circuit component as claimed in claim 1, wherein the dielectric substrate is a foam dielectric substrate.

7. An RF circuit component as claimed in claim 1, wherein the composite fibre veil is in its raw form.

8. An RF circuit component as claimed in claim 1, wherein the composite fibre veil is a non-woven carbon fibre veil.

9. An RF circuit component as claimed in claim 1, wherein the composite fibre veil has been treated in that a surface of the composite fibre veil has a layer of conductive material deposited thereon.

10. An RF circuit component as claimed in claim 9, wherein the layer of conductive material is proximate the dielectric substrate.

11. An RF circuit component as claimed in claim 1, wherein the layer of conductive material has a first thickness in a first region and a second, different thickness in a second region.

12. An RF circuit component as claimed in claim 11, wherein electrical connectors are formed by thicker regions of the layer of conductive material.

13. An RF circuit component as claimed in claim 1, wherein the electrically conductive material is Copper.

14. A composite article comprising an RF circuit component as claimed in claim 1, wherein the RF circuit component is formed as an integral part of the composite article.

15-16. (canceled)

17. A method of manufacturing an RF circuit component, the method comprising:
providing a composite fibre veil and a dielectric substrate;
treating the composite fibre veil with electrically conductive material to impart an electrically conductive property to the composite fibre veil; and
enclosing a part of the dielectric substrate with the treated composite fibre veil so as to delimit a wave propagation region in said part of the dielectric substrate.

18. The method of claim 17, wherein treating the composite fibre veil with electrically conductive material comprises coating the composite fibre veil with a layer of the conductive material, where the layer has a first thickness corresponding to a predetermined conductivity level for the RF circuit component.

19. The method of claim 18, wherein the step of coating the composite fibre veil with a layer of conductive material comprises:
applying the conductive material by thin film deposition for a predetermined time period which corresponds to the first thickness.

20. The method of claim 18, wherein the step of coating the composite fibre veil with a layer of conductive material comprises:
applying the conductive material by thin film deposition for a first predetermined time period in a first surface region of the composite fibre veil to deposit a layer of conductive material having a first thickness in the first surface region; and
applying the conductive material by thin film deposition for a second predetermined time period in a second surface region of the composite fibre veil to deposit a layer of conductive material having a second thickness in the second surface region;
wherein the first time period is different to the second time period and the first thickness is different to the second thickness.

21. The method of claim 17 comprising integrating the composite fibre veil of the RF circuit component with composite materials to form a composite article.

22. The method of claim 21 comprising applying a resin to an assembly of the RF circuit component and composite materials and curing the resin-applied assembly.
